(19) United States
(12) Patent Application Publication
(10) Pub. No.: US 2019/0184629 A1
(43) Pub. Date: Jun. 20, 2019

(54) 3D Printed Footwear Sole with Reinforced Holes for Securing An Upper

(71) Applicant: JKM Technologies, LLC, Charlottesville, VA (US)

(72) Inventor: D. Casey Kerrigan, Charlottesville, VA (US)

(21) Appl. No.: 16/175,071

(22) Filed: Oct. 30, 2018

Related U.S. Application Data
(63) Continuation-in-part of application No. 16/031,972, filed on Jul. 10, 2018.
Application No. 16/031,972 is a continuation of application No. 15/168,767, filed on May 31, 2016, now abandoned.
(60) Provisional application No. 62/169,273, filed on Jun. 1, 2015.

(51) Int. Cl. B29C 64/118; A43B 13/14; A43B 13/28; B29C 64/209; B29C 64/393; B29D 35/12

(52) U.S. Cl. CPC B29C 64/118; A43B 13/14; A43B 13/28; B33Y 10/00; B29C 64/393; B29D 35/122; B29D 35/128; B29C 64/209

(57) ABSTRACT

The present invention relates to a 3D printed sole for footwear that has a plurality of reinforced holes that are useful for securing at least a portion of the sole to a footwear upper without the use of adhesive.

### TECHNICAL FIELD

The present invention relates to additive manufacturing technology, producing on-demand portions of shoes from thermoplastics using fused deposition, and the completed shoes.

### BACKGROUND OF THE INVENTION

The present invention relates to on-demand production of customized thermoplastic shoe components using additive manufacturing, also known as 3D printing. Shoe soles are ideally comprised of material that can provide spring-like properties, responding in tune with ground reaction forces and joint torques when they are at their peak. Certain types of flexible and elastomeric thermoplastics that provide these spring-like properties are desirable to use in shoe soles.

3D printing of thermoplastics may be performed using several techniques known in the art, however none have yet been successfully adapted to printing of customized shoe parts. These techniques include extrusion, sintering, and light polymerization. Extrusion techniques include fused deposition modeling (FDM) and fused filament fabrication (FFF). In these techniques, solid rods or threaded spools of thermoplastic filaments are directed into a heating chamber using a stepper motor, where they are melted. The melted plastic is forced through an extrusion nozzle of an application-specific diameter onto a build surface, where it re-solidifies into the desired shape. The nozzle is moveable in a manner similar to a print head found in a typical ink or laser printer, and the stepper motor and nozzle position are controlled by software to precisely deposit liquid plastic in the correct amount and location. U.S. Pat. No. 5,121,329 to Crump, entitled “Apparatus and Method for Creating Three-Dimensional Objects,” describes the basic form of manufacturing 3D models using extrusion of melted fluid materials through a printing nozzle.

There are many disadvantages to using standard FDM or FFF for mass production of customized shoes. One disadvantage is cost. Flexible filament that would provide both required sufficient structural strength and customizability is commercially available, however it is cost-prohibitive (e.g. $40 to $45 per pound) for use in shoe manufacturing.

Existing FDM and FFF techniques also lack customizability. There is a need to allow a shoe purchaser to precisely customize the composition (for example, the color, stiffness, or springiness) of the thermoplastic used in the shoe. Such customized thermoplastics are not readily available.

Another disadvantage lies in the inability to use heat reactive agents, such as foaming agents, with thermoplastic filament. The use of blowing agents and cellular expanding agents are desirable for certain footwear components. However, commercial thermoplastic filament is typically manufactured by heating source granules or pellets into a liquid, then extruding the liquid into a filament and cooling it. If expansive heat reactive agents such as chemical or physical blowing agents or cellular expanding agents are added during filament manufacturing, they react to the heat and form bubbles in the filament. In addition to destroying the integrity of the filament, this initial expansion prevents a desired later expansion by these agents into foam during reheating (i.e., during the shoe manufacturing process).

Yet another disadvantage lies in the design of commercially available 3D printers. Typically, a thermoplastic filament is fed through a channel by a geared motor. Because the motor rotates, it is not flush with the channel wall, leaving gaps on either side between the gear and the wall. The motor “pulls” the filament from its spool, and “pushes” it toward the heating element. But the filament is flexible like a rope, so pushing it may result in flexures or kinks between the motor and the heating element. These kinks can prevent operation of the printer if they become lodged in the gap between the motor and the channel.

3D printing with thermoplastics also is possible using other techniques. In selective laser sintering (SLS), powdered thermoplastic is heated in-place by a laser, fusing the powder to a layer beneath it. Stereolithography (SLA) printing instead uses a photosensitive liquid resin, or photopolymer, that is cured layer by layer with a UV light. These forms of 3D printing are disadvantageous for different reasons than extrusion printing. One disadvantage is that they cannot be used to create structures with hollow spaces, because uncured powder (in the case of SLS) or liquid (in the case of SLA) would be trapped by the manufacturing process. Another disadvantage is that blowing agents and cellular expanding agents cannot be used. A further disadvantage of SLS and SLA printing is that they both require considerable post-processing to remove powder in the case of SLS, and liquid in the case of SLA, that may be hazardous to handle and/or breathe. A further disadvantage of SLA printing is that photosensitive liquid resin is expensive and non-recyclable, making it cost-prohibitive and impractical for mass production manufacturing.

Footwear assembly is a complicated, many-step process that typically includes attaching the upper to a sole with adhesives in an assembly-line process. The adhesive process is undesirable as it can involve chemicals that make for an unhealthy work environment. Further, the adhesive process is dependent upon using stock-size shoe molds (referred to as “lasts”). Having to use molds for assembly is cumbersome and prohibits the ability to make customized shoe shapes and sizes on-demand. It would be beneficial to manufacture a shoe without the need for either adhesives or molds.

### SUMMARY OF ILLUSTRATED EMBODIMENTS

Illustrated embodiments relate to a device and process that are particularly suitable for mass production manufacturing of customized components, especially footwear. An extruder employs a fused deposition modeling printer having at least one pellet extruder in place of a filament extruder. The pellet extruder uses pellets or granules as the raw material to be melted and extruded onto a build platform. Pellets or granules are drawn from a hopper through a barrel via a rotating screw conveyor (i.e., a feed screw or auger) that traverses through the hopper and barrel. The screw is coupled to a stepper or servo motor. The direction and speed of rotation of the screw is controlled with the motor with rotation in one direction drawing the pellets from the hopper. A heating element is placed at the end of the barrel such that the pellets are melted at the end of the screw and extruded through a nozzle onto the build platform. A series of such 3D printers using pellet based fused deposition modeling may be used for mass production manufacturing. The all-in-one manufacturing process allows for the extrusion of flexible material and the concomitant use of heat-reactive additives such as blowing agents and cellular expanding agents, making this process particularly useful for shoe manufacturing.

Thus, a first embodiment of the invention is a device for manufacturing an object according to a fused deposition process. The device includes a build surface on which the object is manufactured, an extruder for depositing a thermoplastic liquid onto the build surface to form the object, and a control system. The extruder has a nozzle for extruding the thermoplastic liquid. The extruder also has a barrel for holding the thermoplastic liquid, the barrel having a first end that is capped by the nozzle and having a second end. The extruder has a heating element, coupled to the first end of the barrel, for producing the thermoplastic liquid by melting solid thermoplastic pellets. The extruder further has a heat sink, coupled to the barrel between the first end and the second end, for constraining heat generated by the heating element. The extruder also has a hopper for containing the solid thermoplastic pellets, and a screw conveyor for conveying the solid thermoplastic pellets from the hopper into the second end of the barrel, wherein the screw conveyor extends into the second end of the barrel past the heat sink. Finally, the extruder has a motor for rotating the screw conveyor. The control system controls both a flow rate of the thermoplastic liquid, by adjusting rotation of the motor, and a position of the nozzle above the build surface according to a three-dimensional shape of the object.

Variations on the device embodiment are contemplated. In a first variant, the device has a carriage onto which the extruder is mounted, the carriage being controlled by the control system for moving the nozzle along an axis parallel to the build surface. In a second variant, the solid thermoplastic pellets are flexible or elastomeric. In a third variant, the deposited thermoplastic liquid includes an additive customized by a designer of the object. The device may have a port for introducing the additive into the barrel at a rate controlled by the control system, or the additive may be mixed with the solid thermoplastic pellets in the hopper. The additive may be one or more of: a colorant, a chemical blowing agent, and a physical blowing agent. In a fourth variant, the screw conveyor comprises an auger having a thread pitch that decreases between a portion of the screw conveyor near the hopper and an end of the screw conveyor. In a fifth variant, an interior surface of the barrel is grooved along at least a portion of the length of the barrel. In a sixth variant, the control system controls the position of the nozzle according to one or more measurements of biomechanics of a user of the object. In a seventh variant, the device includes a second extruder for depositing a different thermoplastic liquid onto the build surface, wherein the control system controls both a flow rate of the second thermoplastic liquid and the position of the second extruder above the build surface. The object may be a portion of a shoe or other footwear.

A second embodiment of the invention is method of manufacturing an object according to a fused deposition process. The method first includes using a screw conveyor to convey a plurality of solid thermoplastic pellets from a hopper to a barrel. The method next includes using a heating element, coupled to the barrel, to melt the solid thermoplastic pellets within the barrel, thereby producing a thermoplastic liquid. The method finally includes extruding the thermoplastic liquid onto a build surface, through a nozzle that caps one end of the barrel, the extruded thermoplastic liquid thereafter solidifying into the object. A control system controls both a flow rate of the thermoplastic liquid, by adjusting rotation of a motor coupled to the screw conveyor, and a position of the nozzle above the build surface according to a three-dimensional shape of the object.

Variations on the method embodiment are contemplated. In a first variant, the solid thermoplastic pellets are flexible or elastomeric. A second variant includes introducing an additive, customized by a designer of the object, into the thermoplastic liquid either by mixing the additive with the solid thermoplastic pellets in the hopper or by mixing the additive into the barrel through a port on the barrel. The additive may be one or more of: a colorant, a chemical blowing agent, and a physical blowing agent. In a third variant, the screw conveyor comprises an auger having a thread pitch that decreases between a portion of the screw conveyor near the hopper and an end of the screw conveyor. A fourth variant includes controlling, by the control system, the position of the nozzle according to one or more measurements of biomechanics of a user of the object. A fifth variant includes using a second extruder to deposit a different thermoplastic liquid onto the build surface, wherein the control system controls both a flow rate of the second thermoplastic liquid and the position of the second extruder above the build surface. The object may be a portion of a shoe or other footwear.

A third embodiment of the invention is a non-transitory, tangible, computer-readable storage medium comprising computer program code that, when executed by a computer, causes the computer to operate an extruder, thereby causing performance of the method embodiment (or its variants), where the computer acts as the control system.

A fourth embodiment of the invention is a fused deposition, 3D printed sole for footwear that allows for an upper to be attached without the use of adhesives or molds.

### BRIEF DESCRIPTION OF THE DRAWINGS

The foregoing features of the illustrated embodiments will be more readily understood by consulting the following detailed description, taken with reference to the accompanying drawings, in which:

FIG. 1 shows a series of device embodiments of the invention, which may be used for the mass production of objects;

FIG. 2 is a front view of an extruder device embodiment of the invention, in the process of manufacturing an object;

FIG. 3 is a perspective view of the extruder device of FIG. 2, identifying various components;

FIG. 4 shows an exploded view of the extruder device of FIG. 2, identifying further components;

FIGS. 5A and 5B show longitudinal views of interior grooves in an uncapped barrel in accordance with an embodiment of the invention;

FIG. 6 is a flowchart for a method of manufacturing an object in accordance with another embodiment of the invention;

FIG. 7 is a top view of a 3D printed sole that shows the top portion that has (a) a plurality of reinforced openings that pass through the top portion, body portion, and side portion of the sole, (b) a textured surface; and, (c) a repeating image (e.g., word) in the surface;

FIG. 8 is a side view of a 3D printed sole that shows part of a side portion of the sole, including the reinforced openings that pass through the top portion, body portion, and side portion;

FIG. 9 is a bottom view of a 3D printed sole that shows the bottom portion of the sole, including a non-planar tread;

FIG. 10 is a partial top view of a 3D printed sole that shows a close-up perspective of a plurality of reinforced openings that pass through the top portion, body portion, and side portion of the sole;

FIG. 11 is a partial top view of a 3D printed sole that shows a close-up perspective of yarn passing through a plurality of reinforced openings;

FIG. 12 is a partial side view of a 3D printed sole that shows a close-up perspective of yarn that has been crocheted into a plurality of reinforced openings;

FIG. 13 is a partial side view of a 3D printed sole showing an upper that has been crocheted onto a sole; and,

FIG. 14 is a partial side view of a 3D printed sole showing an upper that has been stitched onto a sole.

### DETAILED DESCRIPTION OF ILLUSTRATIVE EMBODIMENTS

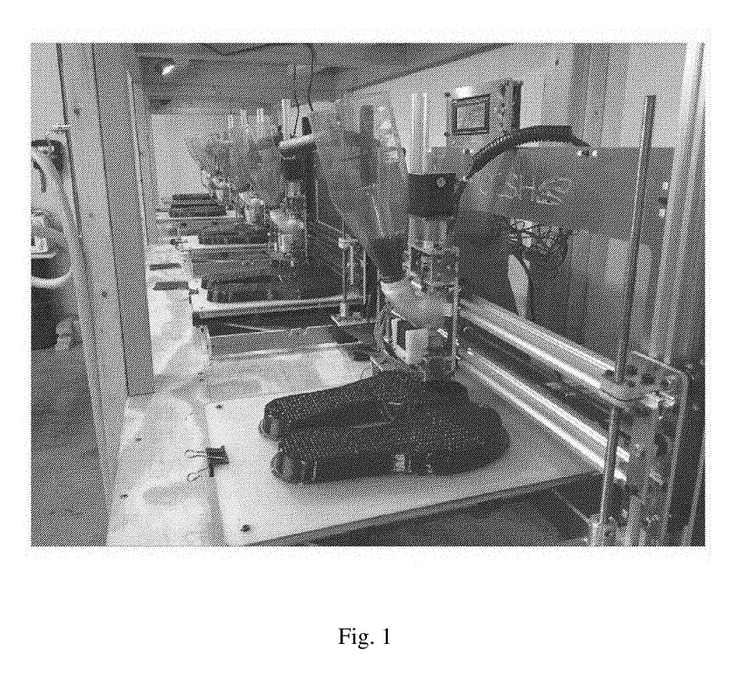

FIG. 1 shows a series of device embodiments of the invention, which may be used for the mass production of objects. It is contemplated that embodiments of the invention, such as those shown in FIG. 1, may be used to provide mass production of customized objects that include various features not produced by existing 3D printers.

Customized footwear may be designed using a customization process. Such a process begins with a shoe designer or a user taking measurements of the user's foot to produce a 3D model of the foot. This model may be stored in any standard data format known in the art. Next, the model may be uploaded to a design customization website. Once there, the user may select a particular style of shoe to construct, based on a template. The user may select a color of the shoe (or portions thereof), as well as any other attributes of the shoe to meet any intended use. Such other attributes may include, for example, structural durability, weight, component material, and so on. Optionally, a shoe designer with expertise in biomechanics may modify the customized shoe design further, to ensure that the shoe will be form fitting where required, loose or flexible where required, to account for various foot anomalies (such as bunions), to provide padding to enhance comfort, to accommodate for anatomical changes that occur with weight bearing activities, and so on. In any event, the finalized shoe design information, including what materials must be present at what three-dimensional locations, is provided to a control system that controls a 3D printer in accordance with an embodiment of the invention. Such control systems are known in the art, and are typically either special purpose, embedded systems, or computer systems having software for programming them to actuate servos and motors to control the extruder.

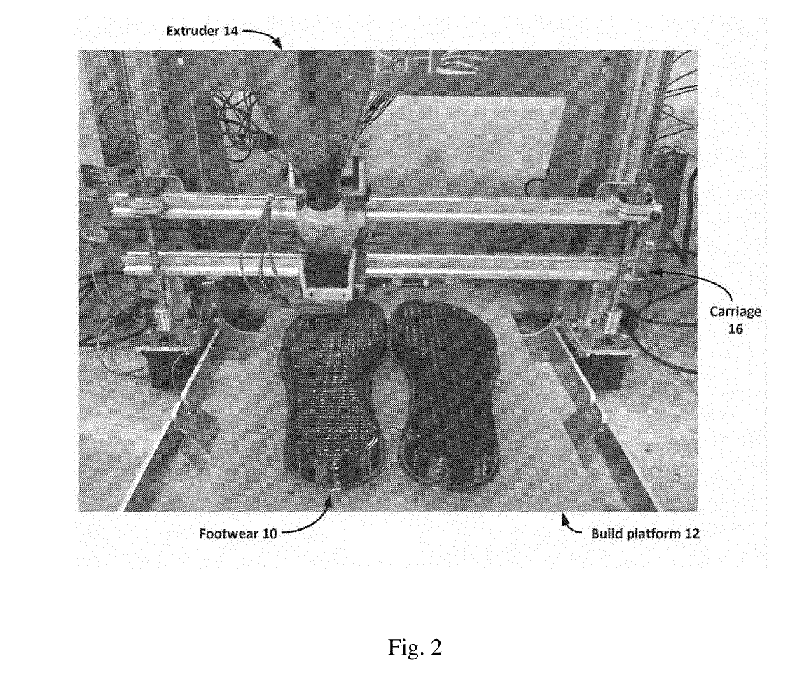

FIG. 2 is a front view of an extruder device embodiment of the invention, in the process of manufacturing an object. The view shows a portion of an object 10 (in this case, a footwear) in the process of being built. The object 10 is made of fused thermoplastic, as described in more detail below. The object 10 rests on a build platform 12. Such build platforms are common in the art of 3D printing and provide a sturdy base on which the object 10 can be constructed. The object 10 is manufactured by depositing small beads of melted thermoplastic from an extruder 14, described in more detail below. The thermoplastic is solid at room temperature, and as it cools, it solidifies into the desired shape.

3D printing devices have a mechanism for moving an extruder 14 in three dimensions relative to the build platform 12. In the embodiment of FIG. 1, the extruder 14 is mounted on a carriage 16 that permits the extruder 14 to slide back and forth along an X-axis parallel to the build surface (left to right), using a belt and motors to control the exact position of the extruder 14. Either the carriage 16 or the build platform 12 may move in a perpendicular Y-axis (front to back) to position the extruder 14 correctly. The extruder 14 may be lifted and lowered along a vertical Z-axis using screws and motors that adjust the height of the extruder mounting bracket on the carriage 16. The movement of the carriage 16 via a stepper or servo motor is controlled with a 3D printer control system and software, as known in the art.

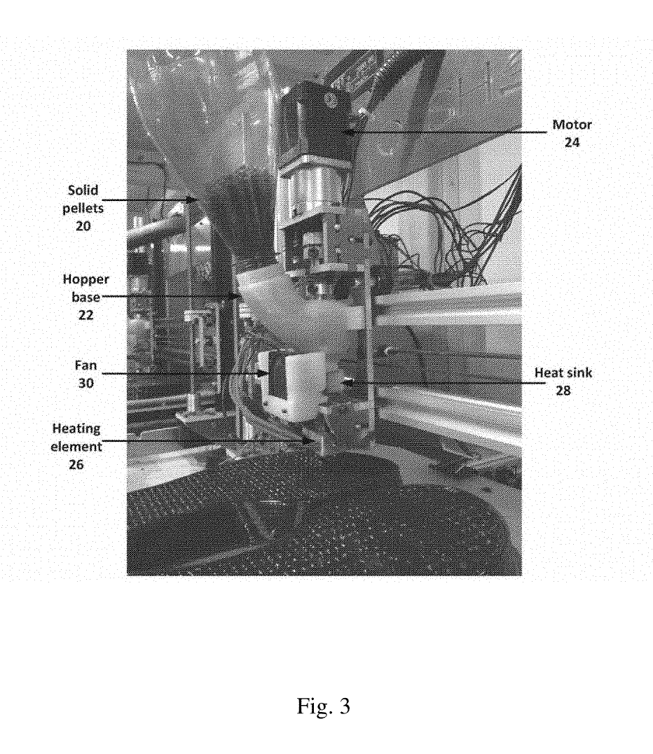

FIG. 3 is a perspective view of the extruder 14 of FIG. 2, identifying various components. The extruder 14 includes a hopper containing solid thermoplastic pellets 20. These pellets, or granules, are eventually melted to form droplets of liquid that are precisely placed to solidify into the object 10. Typical pellets are 3 mm to 5 mm in diameter. The hopper is coupled to the extruder using a hopper base 22.

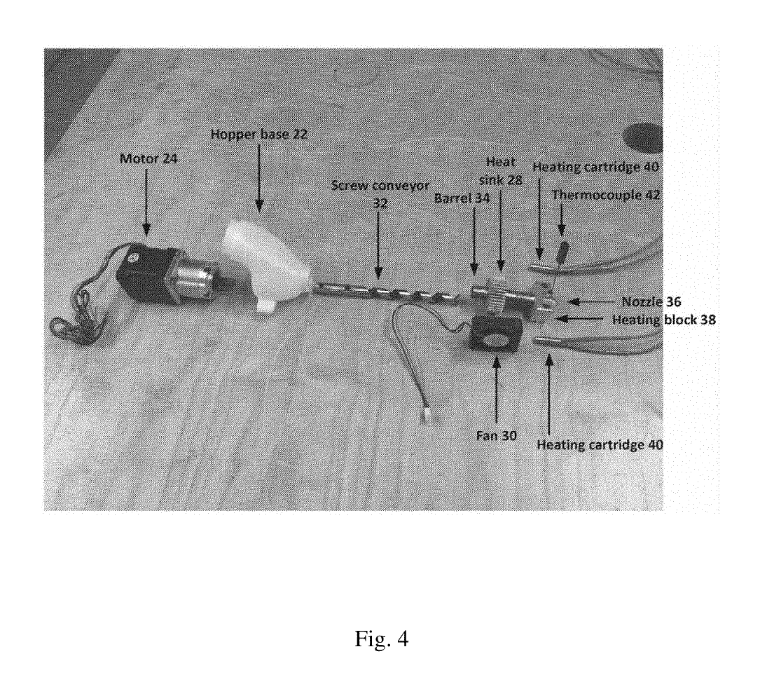

Pellets in the hopper base are drawn into a screw conveyor 32 (shown in FIG. 4) by the force of gravity. The screw conveyor 32 is rotated by a motor 24, visible at the top of the extruder. The motor 24 is preferably geared and may be a stepper or servo motor. Rotating the screw conveyor 32 causes the pellets to be drawn down, at a precisely controlled rate, into a barrel 34 (shown in FIG. 4) to be melted. The rate of extrusion is controlled with a 3D printer controller and software that determine the rotational speed of the motor 24. If the screw is grooved spirally in a right-hand direction, then a counter-clockwise rotation will extrude the material and a clockwise rotation will retract the material.

Controlling the flow rate is crucial. In 3D printers for large-scale industrial projects, liquid thermoplastics are subjected to a great deal of pressure. Such large pressures would be destructive to the extruder 14. In particular, the motor 24 can only rotate the screw conveyor 32 against small resistive pressures and attempting to rotate it against a larger pressure may damage the motor 24.

A heating element 26 is coupled to the barrel 34. The heating element 26 melts the thermoplastic pellets in the barrel 34, forming a thermoplastic liquid that is extruded from a nozzle 36 (shown in FIG. 4). More detail of the construction of the heating element 26 is shown in FIG. 4 and described below.

The extruder 14 may include a cooling unit that surrounds the barrel 34 near its top to prevent the pellets from prematurely melting and bridging inside the hopper. In the pictured embodiment, the cooling unit consists of a heat sink 28 surrounding the barrel 34, and a fan 30 that cools the heat sink 28. The heat sink 28 conductively absorbs heat generated by the heating element 26, constraining the heat to a lower portion of the barrel 34. The fan 30 convectively dissipates heat captured by the heat sink 28. In another embodiment, the cooling unit consists of a water-cooled aluminum block that surrounds the barrel 34, where the block conductively absorbs heat from the heating element 26 and the water conductively absorbs, then carries away, heat from the block. A person having ordinary skill in the art may appreciate other configurations of the cooling unit.

FIG. 4 shows an exploded view of the extruder device of FIG. 2, identifying further components. The screw conveyor 32, barrel 34, and nozzle 36 mentioned above are visible. Also visible are the constituent components of the heating element 26; namely, a heating block 38, two heating cartridges 40a, 40b, and a thermocouple 42.

The feed conveyor 32 is a screw or auger coupled to a motor 24 at one end. The feed conveyor 32 is positioned such that one portion traverses the hopper base 22 to draw in solid thermoplastic pellets, and the other portion traverses the inside of the barrel 34 to safely deposit the pellets within. The screw is preferably between 8 mm and 15 mm in diameter.

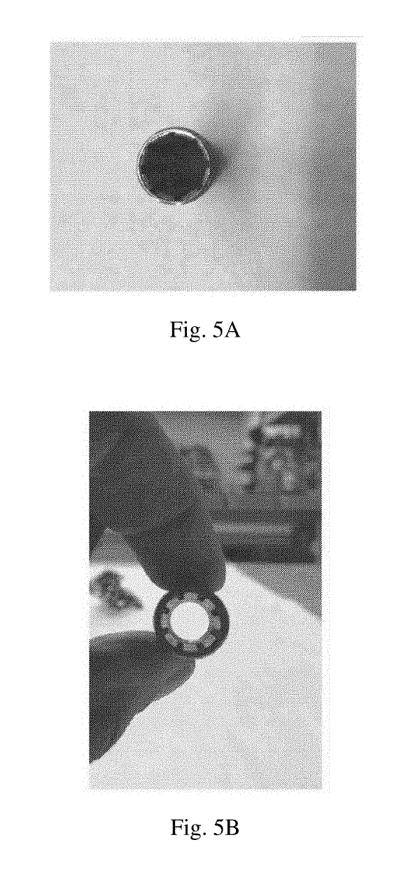

The barrel 34 preferably has 6-12 grooves that are between 0.5 mm and 1.5 mm deep on its internal surface, that run for at least a portion of the length of the barrel 34 beginning at the top near the hopper base 22. The barrel is preferably between 40 mm and 80 mm in length and the grooved section is preferably between 20 mm and 60 mm in length. A view of these grooves is provided in FIGS. 5A, 5B. The purpose of the grooves is to improve the feeding of the pellets, which is a concern given the much smaller size of the screw and barrel as compared to the significantly larger sizes used in prior art injection molding and plastic extrusion manufacturing. In particular, the surface of the screw must be very smooth, while the surface of the barrel must be rough. Providing these grooves aids in evening out the fluid flow.

The nozzle 36 preferably has a diameter between 0.5 mm and 1.0 mm. This diameter is larger than standard desktop 3D printer nozzles, which are typically 0.3 mm to 0.4 mm. The wider nozzle improves printing speed. A narrower diameter is used when extruding foam, since the foaming agent causes the extruded thermoplastic to expand to approximately 0.8 mm to 1.0 mm.

A heating element 26 is placed toward the end of the barrel. In the embodiment of FIG. 4, the heating element 26 includes an aluminum heating block 38 that is machined such that the end of the barrel 34 can be fitted into its top, an extrusion nozzle 36 can be fitted into its bottom, and heating cartridges 40 and a thermocouple 42 can be fitted into the sides. The heating cartridges 40 may be standard resistive cartridges known in the art, that heat to a high temperature when a current is passed through them. The thermocouple 42 may be used by the control system to monitor the actual temperature of the heating block 38. If the temperature is not optimal, the control system may raise or lower it by adjusting the amount of current that passes through the heating cartridges 40. In this way, the control system may act as a closed-loop controller to keep the heating element 26 at an optimal melt temperature.

In one embodiment, an individual 3D printer may contain multiple extruders 14. This embodiment can be used to enable the printing of multiple materials without the need to refill the hopper. Two pellet extruders are each mounted onto their own individual carriages that move along a horizontal axis. In this embodiment, the idle extruder is parked off to the side of the build platform while the active pellet extruder extrudes. This embodiment eliminates potential drooling from the idle pellet extruder.

The physical properties of the extruded liquid may be altered in several different ways. Various suitable thermoplastic materials may be used, including polyurethane, nylon, polyether block amide, or other such materials known in the art. To alter the density of the manufactured object, additives including chemical blowing agents and cellular expanding agents can be mixed together with the pellets and placed into the hopper that will result in foam being extruded from the nozzle. Structural materials like carbon fiber filaments for strength also may be added. Alternatively, additives can be fed separately through a port toward the end of the barrel. For example, a physical blowing agent in the form of a gas or a supercritical fluid is fed through the port; the blowing agent expands when exposed to the heat of the heating element 26, forming bubbles that turn the liquid into a foam. The use of a port advantageously permits introduction of the additives by the control system at a precisely controlled rate, for example by controlling the flow rate of a precision pump. In this manner, the control system can vary the composition of the deposited thermoplastic liquid over time, in a customizable manner, to form a 3D printed object with a non-uniform composition of materials.

In one embodiment the spiral grooves of the screw are such that the space for the material inside the screw and barrel is greater at the top near the hopper than it is at the bottom near the nozzle.

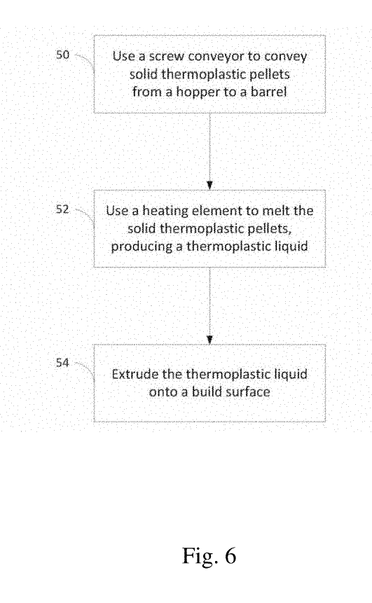

FIG. 6 is a flowchart for a method of manufacturing an object in accordance with another embodiment of the invention. The method begins with a process 50, which uses a screw conveyor to convey a plurality of solid thermoplastic pellets from a hopper to a barrel. The method continues with a process 52, which uses a heating element, coupled to the barrel, to melt the solid thermoplastic pellets within the barrel, thereby producing a thermoplastic liquid. The method concludes with a process 54, which extrudes the thermoplastic liquid onto a build surface, through a nozzle that caps one end of the barrel, the extruded thermoplastic liquid thereafter solidifying into the object. Throughout the processes of FIG. 6, a control system controls both a flow rate of the thermoplastic liquid, by adjusting rotation of a stepper or servo motor coupled to the screw conveyor, and a position of the nozzle above the build surface according to a three-dimensional shape of the object.

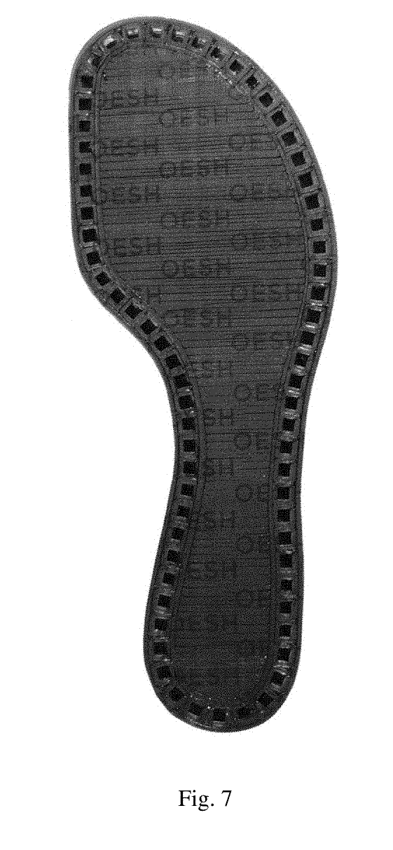

FIG. 7 is a top view of a 3D printed sole in accordance with another embodiment of the invention. FIG. 7 shows the top portion that has (a) a plurality of reinforced openings that pass through the top portion, body portion, and side portion of the sole, (b) a textured surface; and, (c) a repeating image (e.g., word) in the surface.

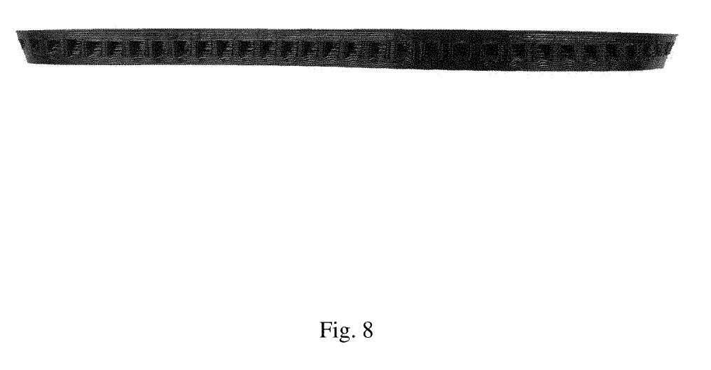

FIG. 8 is a side view of a 3D printed sole in accordance with another embodiment of the invention. FIG. 8 shows part of a side portion of the sole, including the reinforced openings that pass through the top portion, body portion, and side portion. The side view shown in FIG. 8 also allows one to see the numerous layers that were printed in order to form the sole.

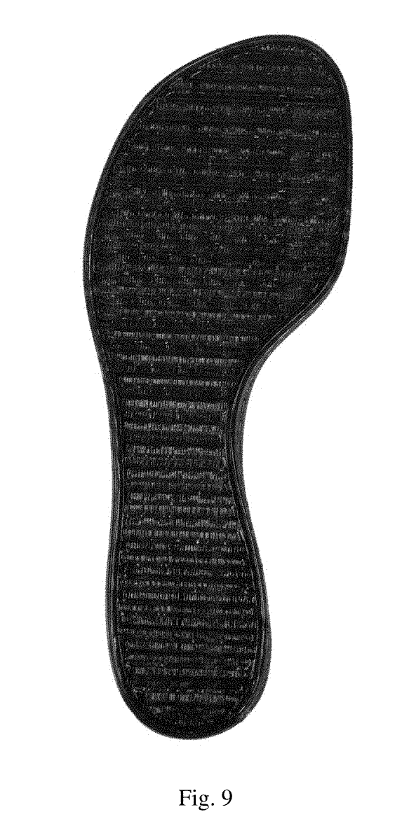

FIG. 9 is a bottom view of a 3D printed sole in accordance with another embodiment of the invention. FIG. 9 shows the bottom portion of the sole, including a non-planar tread that is formed during the 3D printing process.

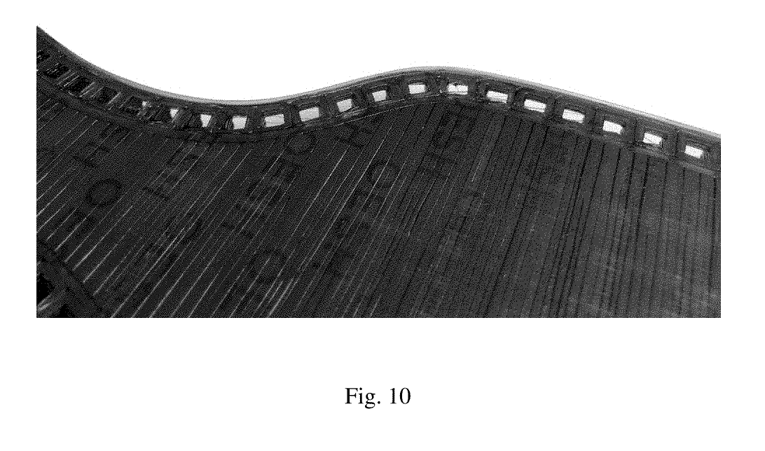

FIG. 10 is a partial top view of a 3D printed sole in accordance with another embodiment of the invention. FIG. 10 shows a close-up perspective of a plurality of reinforced openings that pass through the top portion, body portion, and side portion of the sole.

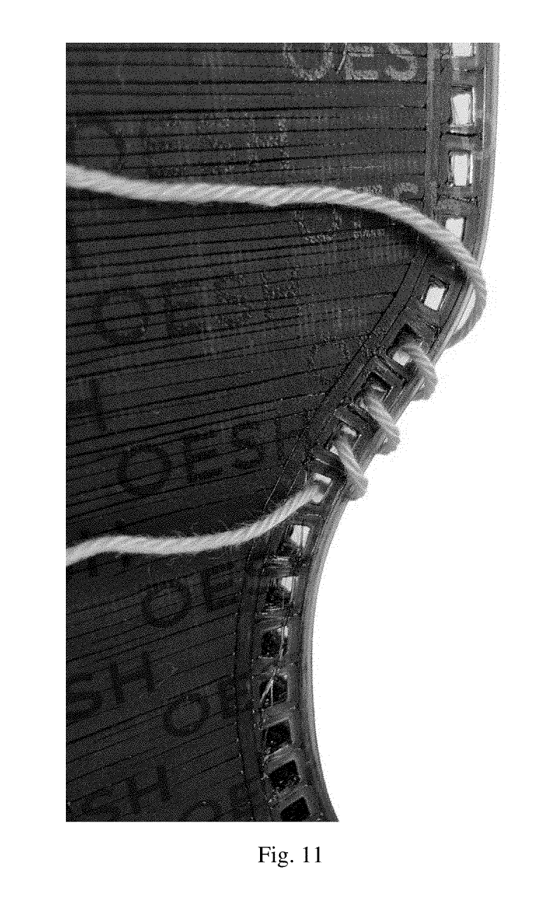

FIG. 11 is a partial top view of a 3D printed sole in accordance with another embodiment of the invention. FIG. 11 shows a close-up perspective of yarn passing through a plurality of reinforced openings. The yarn has been loosely threaded through the openings to more clearly show the openings.

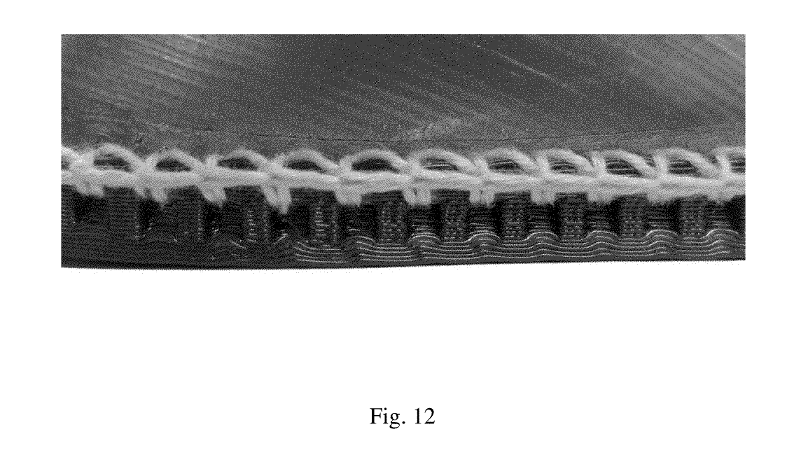

FIG. 12 is a partial side view of a 3D printed sole in accordance with another embodiment of the invention. FIG. 12 shows a close-up perspective of yarn that has been crocheted into a plurality of reinforced openings. In another embodiment, an upper is attached to this portion of the sole via the crocheted yarn.

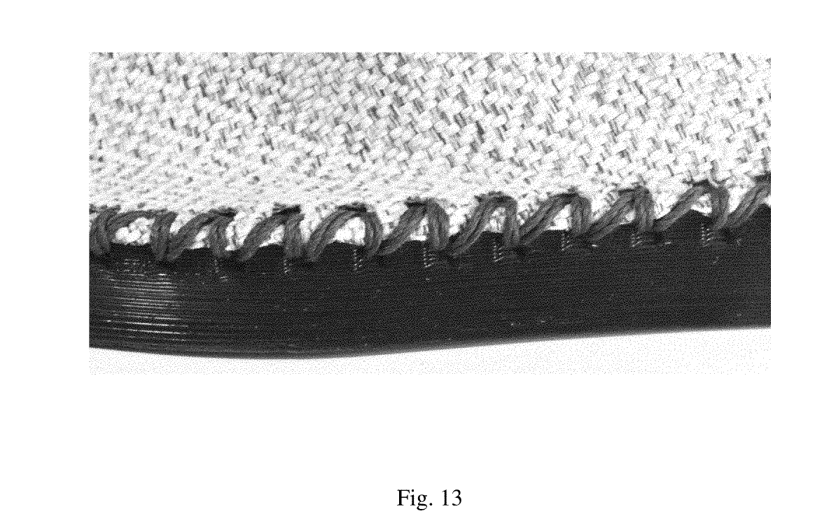

FIG. 13 is a partial side view of a 3D printed sole in accordance with another embodiment of the invention. FIG. 13 shows part of an upper that has been crocheted onto the sole.

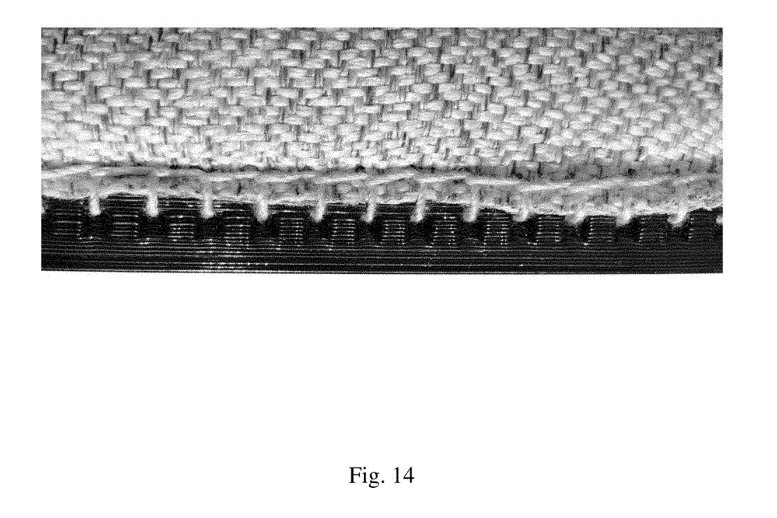

FIG. 14 is a partial side view of a 3D printed sole in accordance with another embodiment of the invention. FIG. 14 shows part of an upper that has been stitched onto the sole.

In on embodiment, the present invention provides a fused deposition, 3D printed sole for footwear, comprising:
a. a top portion (foot contacting surface, which is typically smooth, but is optionally textured to prevent a foot, sock or insole from sliding);
b. a bottom portion (outsole or the ground contacting surface);
c. a side portion that circumscribes the sole (outer edge of the sole); and,
d. a body portion that is in contact with the top, bottom, and side portions;
   wherein:

the printed sole, further comprises: a plurality of reinforced openings passing through the top, body, and side portions;

the reinforced openings are located near and trace at least a part of the side portion and the perimeter of the top portion; and,

the reinforced openings are sized to receive yarn for stitching or for crocheting.

The yarn (which includes thread, a type of yarn) can be made from natural fibers or filament (e.g., cotton, linen, wool, hemp, jute, silk, or leather) or synthetic fibers or filament (e.g., polyester, nylon, or thermoplastic elastomer), or, a combination thereof; and can be of various thicknesses (e.g., for hand or machine stitching or crocheting) for attaching at an upper to at least part of the fused deposition, 3D printed sole via the reinforced openings; decoratively stitching or crocheting the reinforced openings; or, a combination thereof.

The reinforced openings are formed by fused deposition and 3D printing using a CAD model and a 3D printing slicing algorithm. The reinforced openings are angular (i.e., neither perpendicular nor parallel) to the flat surface of the top portion and pass through the top, body, and side portions (but not the bottom portion).

In one embodiment, the sole is flat (the height of the side does not vary from the front (toe area) to the back (heel area) of the sole or from the lateral side to the medial side of the sole).

In one embodiment, the top portion is textured.

The texture of the top portion is derived from build platform 12. The sole is printed starting with the top portion and finishing with the bottom portion thereby allowing the top portion to reflect the image of build platform 12. Build platform 12 can be composed of various materials (e.g., glass, metal, or plastic) and can be modified by known surface modification techniques, including grinding, polishing, sand blasting, or laser etching to impart the desired texture (e.g., lines, patterns, shapes, or a combination thereof).

The texture can also comprise: an image (e.g., letter(s), word(s), and/or structure(s)). This is accomplished by modifying build platform 12 with the image prior to the 3D printing. There can be singular image or a plurality of images (e.g., a repeating pattern of a company name or logo).

In one embodiment, the texture of the top portion, further comprises: an image.

In one embodiment, the image is a company name or logo.

In one embodiment, the sole, further comprises: an upper that is attached via crocheting or stitching to the sole via the plurality of openings.

The upper can be attached to all reinforced openings (e.g., the upper is attached to the entire top portion). Alternatively, the upper can be attached to only a portion of the reinforced openings (e.g., the upper is attached to the openings in the front half of the sole). When only a portion of reinforced openings are used to attach the upper, the remaining openings can be left unaltered or can further comprise yarn that is crocheted or stitched through them (e.g., for decoration).

In one embodiment, the upper is attached via crocheting upward from a plurality of the openings to the upper.

In one embodiment, the reinforced openings trace a substantial (>50% of the circumference) part of the side portion and the perimeter of the top portion.

In one embodiment, the reinforced openings trace the entirety (100% of the circumference) of the side portion and the perimeter of the top portion.

The reinforced openings can be unevenly or evenly spaced along the side portion and the perimeter of the top portion. The openings can also trace only a part or all of the side portion and the perimeter of the top portion (e.g., see FIGS. 7 and 8). For example, from 10, 20, 30, 40, 50, 60, 70, 80, 90, 95, to 100% of the side portion and the perimeter of the top portion can have reinforced openings.

In one embodiment, the sole, comprises: at least 10, 20, 30, 40, 50, or 60 reinforced openings. Alternatively, the sole, comprises: from 5, 10, 15, 20, 25, 30, 35, 40, 45, 50, 55, 60, 65, 70, 75, 80, 85, 90, 95, 100, 105, 110, 115, 120, to 125 reinforced openings (further examples include from (a) 20-100, (b) 40-80, and (c) 60-75 openings).

In one embodiment, the sole, comprises: 70 reinforced openings.

In one embodiment, the bottom portion, comprises: a non-planar tread (to provide traction for a shoe formed from the sole).

In one embodiment, the present invention provides a kit, comprising:
a. the sole of the present invention;
b. an upper; and,
c. yarn in an amount and size sufficient to attach at least a portion of the upper to the sole via the openings in the sole.

In one embodiment, the kit, further comprises: printed instructions. The instructions can teach a purchaser how to assemble the shoe or can provide directions to instructions (e.g., a link to a website).

Although various exemplary embodiments of the invention have been disclosed, it should be apparent to those skilled in the art that various changes and modifications can be made which will achieve some of the advantages of the invention without departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Numerous modifications and variations of the present invention are possible considering the above teachings. It is therefore to be understood that within the scope of the appended claims, the invention may be practiced otherwise that as specifically described herein.

We claim:

1. A fused deposition, 3D printed sole for footwear, comprising:
i. a top portion;
ii. a bottom portion;
iii. a side portion that circumscribes the sole; and,
iv. a body portion that is in contact with the top, bottom, and side portions;
wherein:
the printed sole, further comprises: a plurality of reinforced openings passing through the top, body, and side portions;
the reinforced openings are located near and trace at least a part of the side portion and the perimeter of the top portion; and,
the reinforced openings are sized to receive yarn for stitching or for crocheting.

2. The sole of claim 1, wherein the sole is flat.

3. The sole of claim 1, wherein the top portion, further comprises: an image.

4. The sole of claim 3, wherein the image is a company name or logo.

5. The sole of claim 1, wherein the top portion is textured.

6. The sole of claim 5, wherein the texture of the top portion, further comprises: an image.

7. The sole of claim 6, wherein the image is a company name or logo.

8. The sole of claim 1, further comprising: an upper that is attached via crocheting or stitching to the sole via the plurality of openings.

9. The sole of claim 8, wherein the upper is attached via crocheting upward from the plurality of the openings to the upper.

10. The sole of claim 1, wherein the reinforced openings are evenly spaced along the side portion and the perimeter of the top portion.

11. The sole of claim 1, wherein the reinforced openings trace a substantial part of the side portion and the perimeter of the top portion.

12. The sole of claim 11, wherein the reinforced openings are evenly spaced.

13. The sole of claim 1, wherein the reinforced openings trace the entirety of the side portion and the perimeter of the top portion.

14. The sole of claim 13, wherein the reinforced openings are evenly spaced.

15. The sole of claim 1, wherein the sole, comprises: at least 10, 20, 30, 40, 50, or 60 reinforced openings.

16. The sole of claim 1, wherein the sole, comprises: from 5, 10, 15, 20, 25, 30, 35, 40, 45, 50, 55, 60, 65, 70, 75, 80, 85, 90, 95, 100, 105, 110, 115, 120, to 125 reinforced openings.

17. The sole of claim 1, wherein the sole, comprises: 70 reinforced openings.

18. The sole of claim 1, wherein the bottom portion, comprises: a non-planar tread.

19. A kit, comprising:
i. sole of claim 1;
ii. an upper; and,
iii. yarn in an amount and size sufficient to attach at least a portion of the upper to the sole via the openings in the sole.

20. The kit of claim 19, further comprising: printed instructions.Z
